(19) United States
(12) Patent Application Publication
(10) Pub. No.: US 2009/0250858 A1
(43) Pub. Date: Oct. 8, 2009

(54) INDEXING TABLE APPARATUS

(76) Inventor: Atsushi Tada, Numazu-Shi (JP)

Correspondence Address: DLA PIPER LLP US, P. O. BOX 2758, RESTON, VA, 20195, US

(21) Appl. No.: 12/416,566

(22) Filed: Apr. 1, 2009

(30) Foreign Application Priority Data
Apr. 4, 2008 (JP) 2008-97887

(51) Int. Cl. B23Q 3/18

(52) U.S. Cl. 269/63

(57) ABSTRACT

There is provided an indexing table apparatus which has enhanced table rigidity by eliminating a portion for cantilever-supporting the load of the table and which can therefore significantly reduce the deformation of the table due to the load of a large-sized workpiece, thus enabling precision machining of the workpiece. The indexing table apparatus includes: a table for placing a workpiece thereon, horizontally supported by a support shaft and having a downwardly-projecting peripheral portion which has a lower sliding surface; a table base having a supporting portion which has a supporting surface on which the sliding surface of the peripheral portion of the table slides, said support shaft being fixed vertically and centrally to the table base; a bearing, mounted to the upper end of the support shaft, for supporting the radial load and the thrust load of the table; a plurality of clamping devices circumferentially disposed at positions radially inside the supporting surface, each clamping device having a clamping shaft that engages a to-be-clamped portion formed on the inner side of the peripheral portion of the table; and a table driving device having a large ring gear secured to the table at a position radially inside the clamping devices.

### BACKGROUND OF THE INVENTION

1. Field of the Invention

The present invention relates to an indexing table apparatus of a machine tool, and more particularly to an indexing table apparatus having enhanced table rigidity even when the table is for machining of a large-sized workpiece.

2. Background Art

Machine tools generally use a table having a Workpiece indexing function. A known indexing table apparatus includes a table, a bearing for supporting the table, a worm wheel provided in a peripheral portion of the table, and a worm which engages the worm wheel and drives the table (see Japanese Patent Laid-Open Publication No. 63-127843). In the conventional indexing table, a sliding surface of the table keeps in contact with a supporting surface of a machine body while the table is rotating in an indexing operation. After the indexing operation, the table is fixed by a clamping means.

In the conventional indexing table, as shown in FIG. 4, when the table 110 rotates, the siding surface 110a of the table slides on the supporting surface 111a of the machine body, and the load of a workpiece on the table 110 is supported by the supporting surface 111a. The worm wheel 113 is provided in the peripheral portion of the table 110; and the peripheral portion of the table 110, lying outside the supporting surface 111a, is cantilever-supported by the supporting surface 111a. Thus, the load of the portion of the workpiece, lying on that peripheral portion of the table which projects outwardly from the supporting surface 111a, is not directly supported but cantilever-supported, which may cause deformation of the table 110.

The deformation of an indexing table having such a structure as described above may be easily reduced, if the table is of a relatively small size, e.g. by thickening the table to enhance the rigidity.

On the other hand, in the case of an indexing table for use in precision machining of a large-sized workpiece, the workpiece can be of approximately the same size as the size of the table. In that case, a workpiece-supporting portion (portion on which the load of a Workpiece applies) lies in a peripheral cantilever-supporting portion of the table. The outer the position of the workpiece-supporting portion is in the table, the larger is the deformation of the table, leading to a larger machining error. The table deformation may thus cause a serious problem in precision machining of a large-sized workpiece.

Recent advancements in control technology have led to the development of machine tools capable of ultraprecision machining of large-sized workpieces, leading to increased use of larger-sized indexing tables. If the thickness of a larger-sized indexing table is increased to enhance the rigidity of the table in order to deal with the table deformation problem, the weight of the table should necessarily increase considerably. The weight increase of the table necessitates an increase in the volume of a motor and enhancement of the strength of a power transmission mechanism in a rotary drive system for the table. This entails the drawback that the entire table apparatus becomes unfavorably large.

### SUMMARY OF THE INVENTION

It is therefore an object of the present invention to solve the above problems in the prior art and provide an indexing table apparatus which has enhanced table rigidity by eliminating a portion for cantilever-supporting the load of the table and which can therefore significantly reduce the deformation of the table due to the load of a large-sized workpiece, thus enabling precision machining of the workpiece.

In order to achieve the object, the present invention provides an indexing table apparatus comprising: a table for placing a workpiece thereon, horizontally supported by a support shaft and having a downwardly-projecting peripheral portion which has a lower sliding surface; a table base having a supporting portion which has a supporting surface on which the sliding surface of the peripheral portion of the table slides, said support shaft being fixed vertically and centrally to the table base; a bearing, mounted to the upper end of the support shaft, for supporting the radial load and the thrust load of the table; a plurality of clamping devices circumferentially disposed at positions radially inside the supporting surface, each clamping device having a clamping shaft that engages a to-be-clamped portion formed on the inner side of the peripheral portion of the table; and a table driving device having a large ring gear secured to the table at a position radially inside the clamping devices.

In a preferred embodiment of the present invention, the clamping devices each include a piston coupled to the clamping shaft, a cylinder fixed to the lower surface of the supporting portion and having an annular cylinder chamber in which the piston is vertically movably housed, and a biasing member for pushing up the clamping shaft; when unclamping the table.

At least an upper portion of the table, including the upper surface on which a workpiece is to be placed, may have a rectangular parallelepiped shape.

According to the indexing table apparatus of the present invention, by eliminating a portion for cantilever-supporting the load of the table to thereby enhance the rigidity of the table, it becomes possible to reduce the deformation of the table due to the load of a large-sized workpiece, enabling precision machining of-the workpiece.

### BRIEF DESCRIPTION OF THE DRAWINGS

FIG. 1 is a cross-sectional view showing the main portion of an indexing table apparatus according to an embodiment of the present invention;

FIG. 2 is a cross-sectional view of a clamping device of the indexing table apparatus;

FIG. 3 is a plan view of an example of a table for use in an indexing table apparatus according to the present invention; and

FIG. 4 is a cross-sectional diagram showing a cantilever-supporting structure in a conventional indexing table apparatus.

### DETAILED DESCRIPTION OF THE PREFERRED EMBODIMENT

A preferred embodiment of the indexing table apparatus of the present invention will now be described with reference to the drawings.

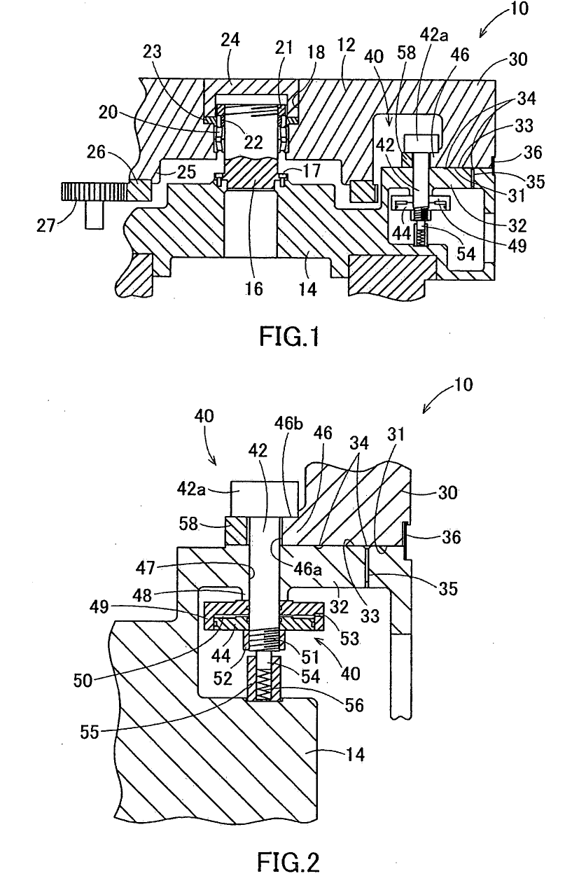

FIG. 1 is a cross-sectional view showing the main portion of an indexing table apparatus according to an embodiment of the present invention. In FIG. 1, reference numeral 10 denotes the entire indexing table apparatus. The indexing table apparatus of this embodiment can be applied in a horizontal boring and milling machine.

The indexing table apparatus 10 includes a table 12 on which a workpiece as a machining object is to be placed, and a table base 14.

A support shaft 16 is vertically and centrally inserted into the table base 14. The support shaft 16 is fixed by bolts 17 to the table base 14. A shaft hole 18 is formed in the center of the table 12. The table 12 is rotatably supported in a horizontal position by the upper end of the support shaft 16 via a bearing 20. A step is formed in the shaft hole 18, and the bearing 20 which supports the table 12 is inserted into the lower smaller-diameter hole. A bearing nut 21 is in screw engagement with the upper end of the support shaft 16. The inner peripheral portion of the bearing 20 is fixed by a collar 22, and the outer peripheral portion of the bearing 20 is fixed by a bearing retainer 23.

In the indexing table apparatus 10 of this embodiment, a conical roller bearing is used as the bearing 20 so as to ensure the axis of rotation with good precision upon receipt of the radial load of the table 12 and to support the thrust load of the table 12 when it rotates. It is also possible to use as the bearing 20 a combination of an angular ball bearing and a thrust roller bearing. Reference numeral 24 denotes a lid which closes the shaft hole 18.

A mechanism for driving the table 12 will now be described. In FIG. 1, reference numeral 26 denotes a large ring spur gear. The large ring spur gear 26 is fixed to a step-like annular raised portion 25 formed in the lower surface of the table 12. The large ring spur gear 26 is in engagement with a small spur gear 27. The small spur gear 27 is driven by a not-shown servo motor. The above table driving device is disposed radially inside the below-described peripheral portion 30 of the table 12.

The peripheral portion 30 of the table 12 will now be described. As shown in FIG. 1, the downwardly-projecting annular peripheral portion 30 is formed in the table 12. The table base 14-side end surface of the peripheral portion 30 constitutes a horizontal sliding surface 31.

The horizontal sliding surface 31 of the peripheral portion 30 faces the upper surface, serving as a supporting surface 33, of the supporting portion 32 of the table base 14. The supporting portion 32 is raised with respect to the central portion of the table base 14. When indexing a workpiece, the table 12 can rotate while the sliding surface 31 slides on the supporting surface 33 of the table base 14. Preferably, as shown in FIG. 1, a plurality of circumferential oil grooves 34 are formed in the supporting surface 33 so that an oil will spread over the entire sliding surface 31. A lubricating oil is supplied through oil passages 35 to the oil grooves 34 by means of a not-shown lubricating device. Such oil grooves may be formed in the sliding surface 31. A cover 36, extending the full length of the outer circumferential boundary line between the table 12 and the table base 14, is attached to cover the boundary line. The cover 36 prevents intrusion of foreign matter, such as chips, into the sliding surface 31.

A description will now be made of clamping devices 40 which, after indexing the table 12, fix the table 12 to the table base 14.

Each clamping device 40 is mainly composed of a clamping shaft 42 and a piston 44. The clamping shaft 42 is comprised of a shaft portion, a head portion 42a formed at the top of the shaft portion, a threaded portion 51 formed at the bottom of the shaft portion, and a spring-receiving portion 54 formed at the bottom of the threaded portion 51. The head portion 42a of the clamping shaft 42 engages the inwardly-projecting to-be-clamped potion 46 of the peripheral portion 30 of the table 12, whereby the table 12 is fixed to the table base 14. Because the table 12 rotates, the inner periphery 46a of the to-be-clamped portion 46 has a constant radius so that the clamping shaft 42 will not interfere with the to-be-clamped portion 46. In this embodiment the clamping devices 40 are circumferentially arranged at regular intervals at positions radially inside the peripheral portion 30 of the table 12.

As shown in FIG. 2, through-holes 47 are formed circumferentially at regular intervals in the supporting portion 32 of the table base 14, and the shaft portion of each clamping shaft 42 is inserted into each through-hole 47. A boss portion 48 is formed around each through-hole 47 in the lower surface of the supporting portion 32. To the boss portion 48 is secured a clamping cylinder 49 which generates a clamping force that clamps the table 12. In the clamping cylinder 49 is formed an annular piston chamber 50 in which the piston 44 is slidably housed. The piston 44 is in engagement with the shaft portion of the clamping shaft 42. A nut 52 is fastened to the threaded portion 51 at the lower end of the clamping shaft 42 so as to limit the lowest position of the piston 44.

Pressurized oil is supplied from a supply inlet 53 to the annular piston chamber 50 by means of a not-shown pressurized oil device. The piston 44 moves downward by the pressurized oil supplied to the piston chamber 50, whereby the head portion 42a of the clamping shaft 42 can clamp the to-be-clamped portion 46 with a large clamping force.

When unclamping the to-be-clamped portion 46, on the other hand, the piston chamber 50 is opened to the atmosphere. In this embodiment the spring-receiving portion 54 at the lower end of the clamping shaft 42 receives the elastic force of a spring 56 housed in a guide 55, and the spring-receiving portion 54 pushes up the clamping shaft 42 with the elastic force of the spring 56. In FIG. 2, reference numeral 58 denotes a regulation block for uniformly regulating the clamping pressure of the clamping shaft 42. The regulation block 58 is fixed e.g. by bolts to the upper surface of the supporting portion 32.

The operation of the thus-constructed indexing table apparatus 10 of this embodiment will now be described.

A description is first made of an unclamping operation as performed prior to an indexing operation of the table 12.

In order to bring the table 12 into the rotatable state, the supply of pressurized. oil to the piston chamber 50 of each clamping device 40 is stopped and, at the same time, the piston chamber 50 is opened to the atmosphere. This operation is carried out by operating a not-shown solenoid valve which switches between a pressurized oil supply line and a vent line. Because of the depressurization in the piton chamber 50, the piston 44 is pushed up by the elastic force of the spring 56 and raised until it reaches the ceiling of the chamber 50. The clamping shaft 42 moves upward with the rise of the piston 44, and the head portion 42a of the clamping shaft 42, which has been pressing on the to-be-clamped portion 46, leaves the clamp surface 46b of the to-be-clamped portion 46, whereby the table 12 is released from the clamped state. An oil has been supplied through the oil grooves 34 to the entire sliding surface 31 of the, table 12. Thus, the table 12 is now in the rotatable state. In this embodiment the load of the table 12 is supported by the central supporting shaft 16 via the bearing 20 and no clamping force is applied on the clamp surface 46b of the to-be-clamped potion 46. Therefore, the table 12 in the unclamped state can rotate while the sliding surface 31 of the table 12 keeps in contact with the supporting surface 33 via the oil. Once the table 12 is brought into the unclamped state, the table 12 can rotate even without the spring 56.

The indexing operation will now be described.

The not-shown servo meter is actuated to rotate the small spur gear 27, transmitting the power to the large ring spur gear 26. The large ring spur gear 26 is fixed to the table 12, and the table 12 rotates together with the large ring spur gear 26. The angle of rotation of the table 12 is detected by a not-shown encoder and, when the table 12 has rotated through a predetermined angle, the rotation of the servo motor is stopped. The supply of the lubricating oil to the oil grooves 34 is stopped upon stoppage of the table 12.

Next, the clamping devices 40 are actuated. When the pressurized oil is supplied to the piston chamber 50 of each clamping cylinder 49, the piston 44 is pressed down by the pressure of the pressurized oil, and the head portion 42a of the clamping shaft 42 presses and holds the to-be-clamped portion 46, lying on the inner side of the peripheral portion 30 of the table 12, against the table base 14. In the clamping operation, the regulation block 58 serves to prevent tilting of the clamping shaft 42, enabling contact of the head portion 42a with the to-be-clamped portion 46 at a uniform pressure. Machining of a workpiece in the indexed position will now be carried out.

The indexing table apparatus of this embodiment has the following structural features:

Firstly, the indexing table apparatus has no cantilever-supporting structure for the table 12, and therefore the apparatus can have enhanced table rigidity.

In particular, the bearing 20 which can receive also the thrust load is provided in the center of the table 12, the sliding surface 31 is provided in the outermost portion of the table 12, and the clamping devices 40 are provided radially inside the sliding surface 31. In addition, the large ring spur gear 26 for power transmission is disposed below the table 12 and inside the circumference along which the clamping devices 40 are disposed.

Such arrangement of the elements of the apparatus enables complete elimination of a cantilever-supporting structure from the table 12. Thus, unlike the conventional indexing table shown in FIG. 4, which must have a cantilever portion radially outside the sliding surface 110a, the present indexing table apparatus has high table rigidity.

Secondly, the indexing table apparatus of this embodiment can have a table structure suited for machining of a large-sized Workpiece.

In particular, the apparatus does not employ a cantilever-supporting structure even when the table 12 is a large-sized one, having a large diameter, adapted to machining a large-sized workpiece. There is, therefore, no need to make the table 12 thick enough to ensure its rigidity. Instead, a table rigidity sufficient for precision machining can be secured even When a large-sized workpiece is placed on the table 12 having a relatively small thickness.

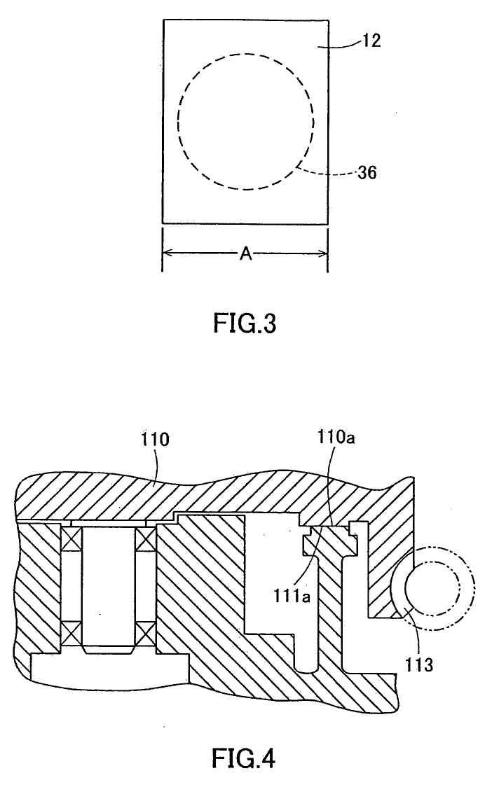

The table 12 may have a cylindrical or cubic shape. Alternatively, as shown in FIG. 3, only the upper side of the table 12 may have a rectangular parallelepiped shape, e.g. having a width A of not less than 1300 mm, to place a rectangular parallelepiped workpiece on it.

What is claimed is:

1. An indexing table apparatus comprising:
a table for placing a workpiece thereon, horizontally supported by a support shaft and having a downwardly-projecting peripheral portion which has a lower sliding surface;
a table base having a supporting portion which has a supporting surface on which the sliding surface of the peripheral portion of the table slides, said support shaft being fixed vertically and centrally to the table base;
a bearing, mounted to the upper end of the support shaft, for supporting the radial load and the thrust load of the table;
a plurality of clamping devices circumferentially disposed at positions radially inside the supporting surface, each clamping device having a clamping shaft that engages a to-be-clamped portion formed on the inner side of the peripheral portion of the table; and
a table driving device having a large ring gear secured to the table at a position radially inside the clamping devices.

2. The indexing table apparatus according to claim 1, wherein the clamping devices each include a piston coupled to the clamping shaft, a cylinder fixed to the lower surface of the supporting portion and having an annular cylinder chamber in which the piston is vertically movably housed, and a biasing member for pushing up the clamping shaft when unclamping the table.

3. The indexing table apparatus according to claim 2, wherein each clamping device is provided with a regulation block for contact with the lower surface of a head portion of the clamping shaft to uniformly regulate the clamping pressure of the head portion of the clamping shaft.

4. The indexing table apparatus according to claim 1, wherein an oil groove is formed in the sliding surface or the supporting surface.

5. The indexing table apparatus according to claim 1, wherein a cover, extending the full length of the outer circumferential boundary line between the sliding surface of the table and the supporting surface of the table base, is provided to cover the boundary line.

6. The indexing table apparatus according to claim 1, wherein the bearing is a conical roller bearing.

7. The indexing table apparatus according to claim 1, wherein at least an upper portion of the table, including the upper surface on which a workpiece is to be placed, has a rectangular parallelepiped shape.
